(19) United States
(12) Patent Application Publication
(10) Pub. No.: US 2016/0271007 A1
(43) Pub. Date: Sep. 22, 2016

(54) Sexual Stimulator

(71) Applicant: Gerald Leonard Kolkind, Eagan, MN (US)

(72) Inventor: Gerald Leonard Kolkind, Eagan, MN (US)

(21) Appl. No.: 15/069,241

(22) Filed: Mar. 14, 2016

Related U.S. Application Data
(60) Provisional application No. 62/133,886, filed on Mar. 16, 2015.

(51) Int. Cl. A61H 19/00

(52) U.S. Cl. CPC A61H 19/34; A61H 2201/165; A61H 2201/163

(57) ABSTRACT

A device for providing clitoral area stimulation. The device is comprised of an independent positionable protrusion that is affixed to the body of a sexual partner. The device is affixed through the use of adhesive tape, dry adhesive, liquid adhesive, self-adhesive, suction and/or or other means, and is positioned to the area of a sexual partner's body that opposes the female's clitoral area when aligned for sexual activity; allowing protrusion to clitoral area contact during the sexual act. Once affixed, the device maintains its position and proper alignment with the clitoral area. The device can be utilized by heterosexual couples as well as same-sex female couples. The device can be made from edible material. The device can be used as a masturbatory tool. The device will generally have one affixing surface that may be planar, concave or convex. The device is comprised of one or more materials or layers of materials, including those that may be textile in nature. Different materials used in its manufacture will provide differing physical properties, such as heat transfer, firmness and pliability, resulting in differing clitoral stimulation. Different materials used in its manufacture will provide differing physical properties resulting in differing affixation predispositions. The device's clitoral contact surface profile may be planar, radial or irregular. The device's clitoral contact surface may be smooth or of a multitude of various surface finishes, textures and may possess ridges, bumps, depressions, hair or hair like features and secondary surface protrusions resulting in differing levels of clitoral stimulation. The device's clitoral contact surface may possess concave features resulting in differing levels of clitoral stimulation. The device can be made in different functional design schemes that will facilitate differing levels of clitoral hood retraction resulting in differing levels of clitoral stimulation intensity. The device can be made in various sizes, forms, shapes, profiles and outer perimeter contours that result in differing levels of clitoral stimulation. The device can be made in a multitude of different aesthetic styles, shapes and designs. The affixing surface perimeter can be larger than the clitoral contact surface perimeter to increase the dimensional area of the affixing surface. The device can be made with a hollow, solid, semi-solid or liquid filled center, or a combination thereof. The device can be made of inconspicuous clear material or in various opaque or translucent colors, luminescent, or a combination thereof. The device can be manufactured through the use of molds, die cutting, impression, injection, extrusion or other manufacturing techniques. The device can be disposed of after use. The disposable nature of the device will eliminate the need for cleaning, sterilization and other sanitary precautions. The device can have one or more concave affixing surfaces allowing affixation through suction or suction plus adhesive. The device can possess an extension to laterally distance the affixation surface from the clitoral contact surface. The device's affixation surface extension can be made of a multitude of different materials. The device's affixation surface extension can be made in a multitude of different lengths, width, thicknesses, shapes and forms. The device can have multiple affixation surface extensions. The device's affixation surface extensions can have areas void of material. The device can possess a multidimensional 2-sided clitoral contact surface along with an extension of its affixation surface. The device's multidimensional 2-sided clitoral contact surface can move independently from the extension when attached with a swivel type connector, an area of the extension having reduced girth, an area of the extension consisting of a material of greater flexibility, or other means. The device can contain a motion creating device. The device can be affixed below the epidermis through surgical implantation or injection. Other embodiments are described and shown.

### CROSS-REFERENCE TO RELATED APPLICATIONS

This application claims the benefit of provisional patent application Ser. No. 62/133,886, filed 2015 Mar. 16 by the present inventor.

### BACKGROUND

### Prior Art

The following is a tabulation of some prior art that presently appears relevant:

U.S. Patents

| Patent Number | Kind Code | Issue Date | Patentee |
|---|---|---|---|
| 6,179,775 | B1 | 2001 Jan. 30 | Thompson |
| 8,109,869 | B2 | 2012 Feb. 7 | Beaulieu |

U.S. Patent Publications

| Publication Nr. | Kind Code | Publ. Date | Applicant |
|---|---|---|---|
| 2007/0038019 | A1 | 2007 Feb. 15 | Weng |

It has been estimated that 75% of women capable of achieving orgasm are not able to do so through the act of intravaginal sexual intercourse alone. For these women, oral, manual or vibratory clitoral stimulation is required in order to successfully reach climax. This inability to achieve orgasm through intravaginal sexual intercourse can leave women feeling sexually unsatisfied, as well as having a deep emotional yearning for this feminine capability. It also can leave their sexual partners feeling frustrated and inadequate.

There are devices that have been created that endeavor to address this issue and create clitoral stimulation during intravaginal sexual intercourse. These devices are normally associated with a rubbery fob-like protrusion extending out from a ring fitted around the base of the shaft of the penis. The fob's purpose is to make contact with the clitoris during intercourse while the ring holds it in position. There are multiple potential drawbacks with such devices. Since the fob length is fixed, it may not make effective contact with the clitoris due to normal variations in vaginal opening to clitoris distances. The fixed length will also fluctuate by variations in penis shaft diameters. In addition, since the device is positioned using the penis's cylindrical shaft, it will have the potential freedom to rotate about the shaft and lose its desired alignment with the clitoris. These types of devices are also often bulky in size, aesthetically displeasing and uncomfortable for the wearer.

U.S. patent publication 2007/0038019 to Weng discloses a device comprised of a vibrating protrusion extending from a ring that fits around the penis of the female's sexual partner. This device is similar in nature to other fob/penis ring devices and possesses their inherent undesirable qualities.

U.S. Pat. No. 6,179,775 to Thompson discloses a device that is installed in the external genitalia of the female to receive clitoral stimulation. This device is described as providing vibratory stimulation resulting from the interaction of the penis with the device. The stimulation provided by this device is of a non-traditional type that is not consistent with the stimulation created through normal pressure and manipulation of the clitoris. In addition, the installation of the device beneath the sensitive labia minora tissue would be a delicate procedure requiring an acquired skill.

U.S. Pat. No. 8,109,869 to Beaulieu discloses a harness device that includes a vibrating body with protrusions that provide stimulation to the clitoris of the female sexual partner. This large harness assembly would be cumbersome to don, wear and transport, as well as being aesthetically displeasing.

### SUMMARY

In accordance to one embodiment a device for providing clitoral area stimulation comprising of an independent positionable protrusion affixed to the body of a female's sexual partner in the area opposing said female's clitoris when aligned for sexual activity; allowing protrusion to clitoral area contact during the sexual act.

### ADVANTAGES

Accordingly multiple advantages of one or more aspects are as follows: to provide clitoral area stimulation through a device that is affixed to the body of a sexual partner through the use of temporary adhesive or other means; that is independent and autonomous in nature; that is relatively small in size and unobtrusive in appearance; that is easily and quickly affixed or removed; that is fully positionable and accommodating to each individual user's vaginal opening to clitoris distance; that will maintain its position and alignment with the clitoral area once affixed; that can be conveniently and discreetly transported; that can be made of a wide variety of materials with differing physical properties resulting in differing clitoral stimulation; that can be made in various shapes and sizes resulting in differing clitoral stimulation; that can be made with various surface finishes, textures, ridges, bumps and secondary protrusions resulting in differing clitoral stimulation; that can be made of inconspicuous clear material or in various esthetically pleasing colors; that is easily and inexpensively manufactured; that can be cost effectively disposed of after use; that will not require cleaning or sterilization after use due to its disposable nature; that may be made of edible material; that may contain a vibration creating device; that can be used as a masturbatory tool. Other advantages of one or more aspects will be apparent from a consideration of the drawing and ensuing description.

### DRAWINGS

### Figures

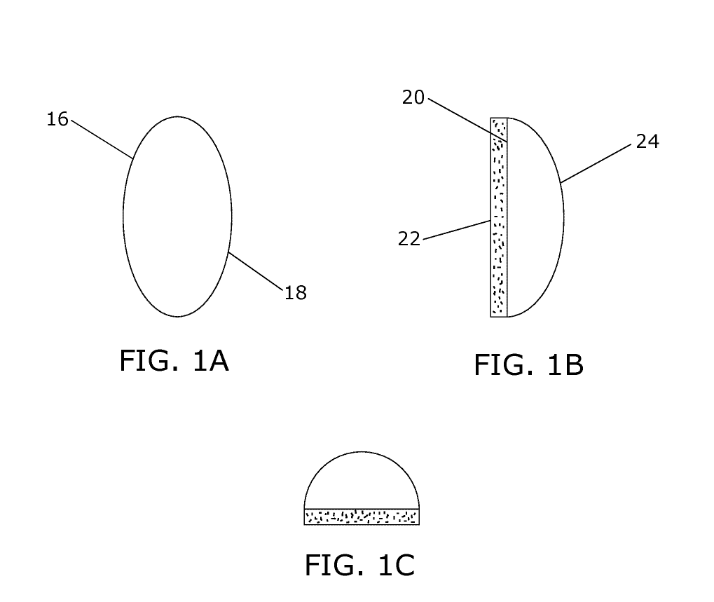

FIG. 1A to 1C show front, side and end perspective views of a basic device in accordance to a first embodiment of the present invention.

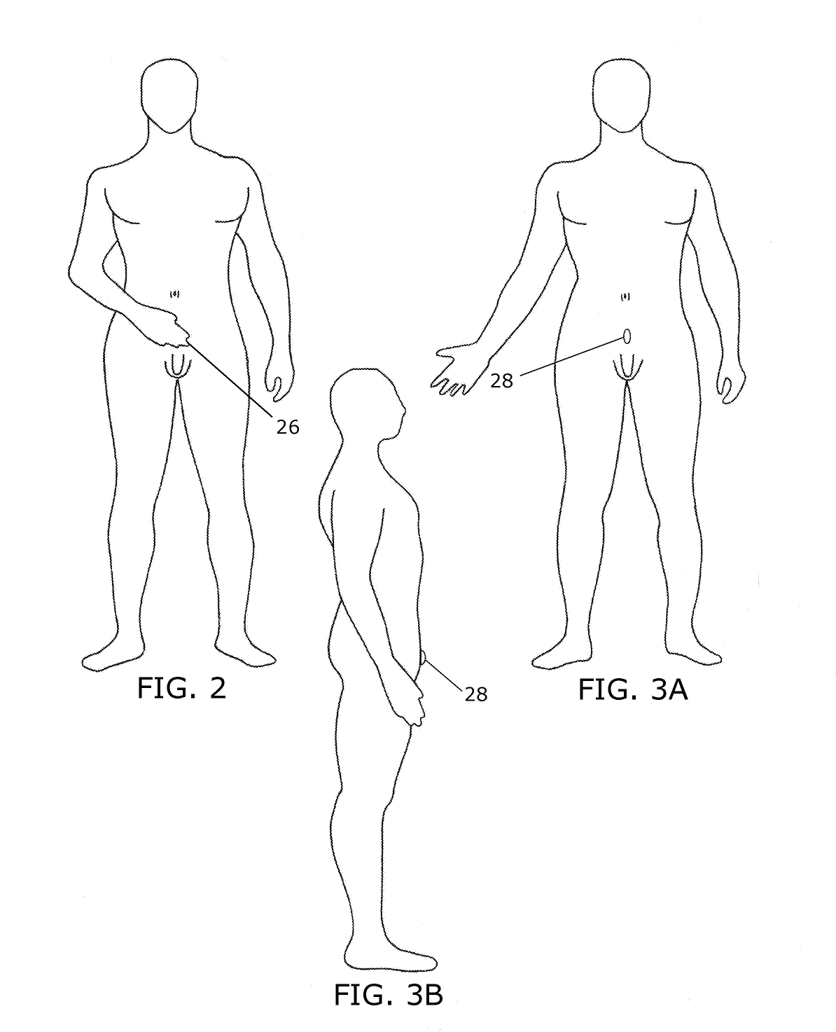

FIG. 2 is a front view of a user positioning and affixing the device of FIG. 1 to their body.

FIGS. 3A and 3B show front and side view of a user with the device of FIG. 1 affixed to their body.

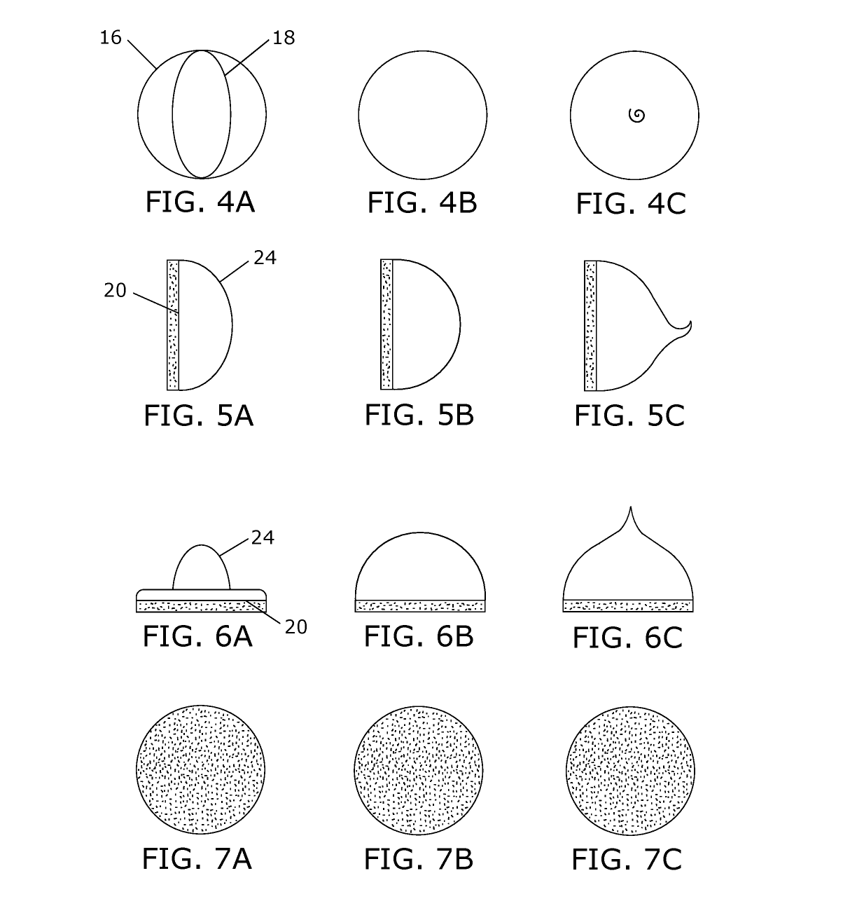

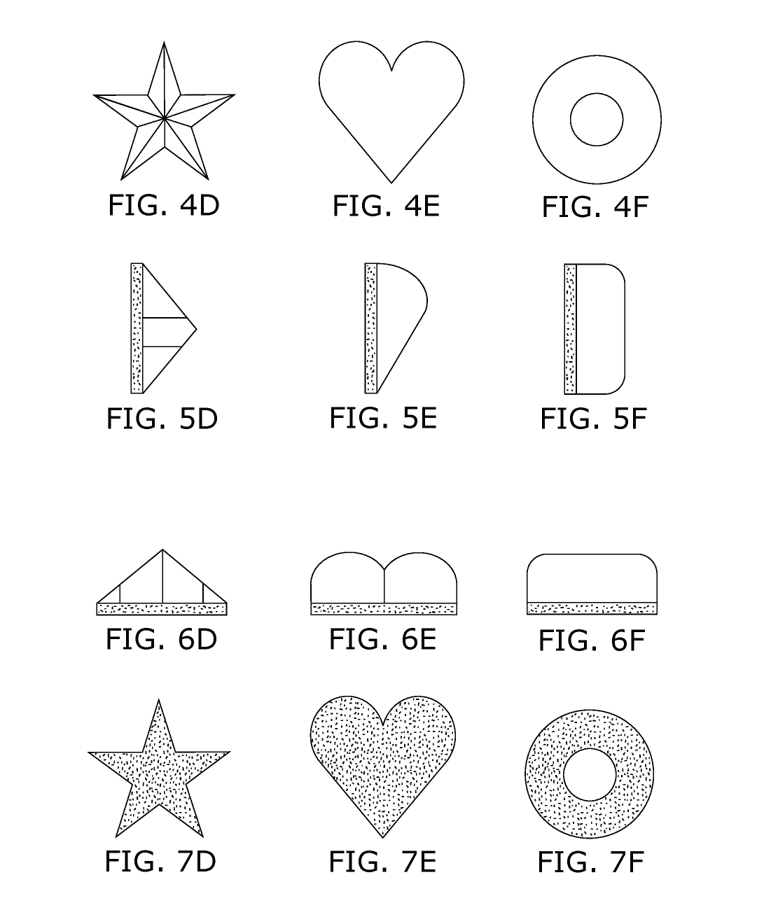

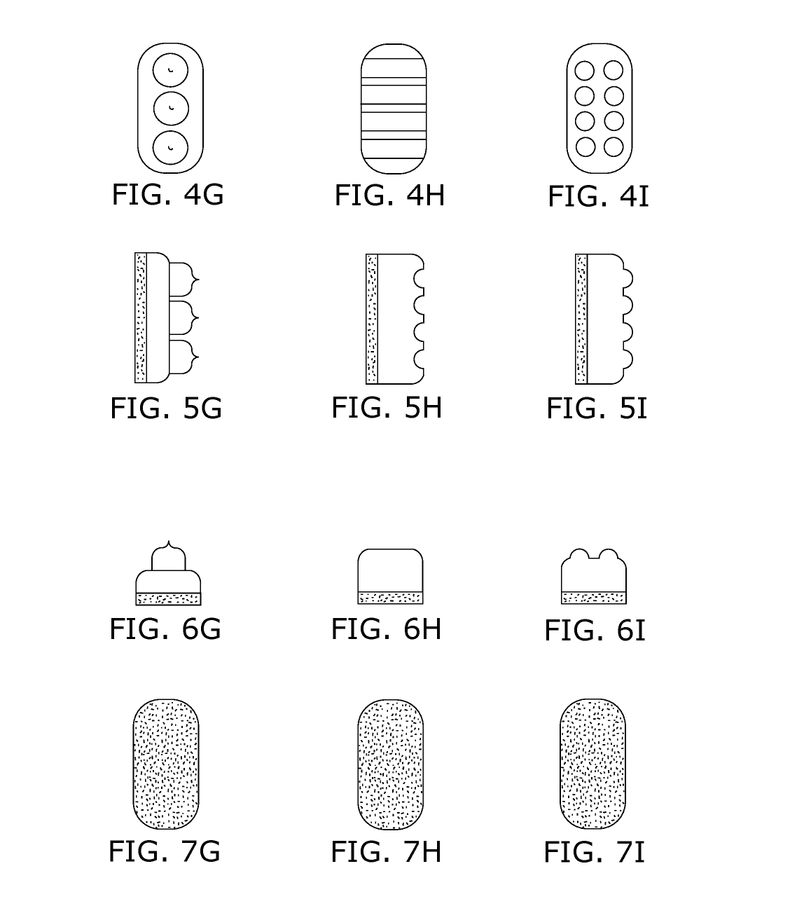

FIGS. 4A to 4I show front views of example shape and form variations of the device of FIG. 1.

FIGS. 5A to 5I show side views of example shape and form variations of the device of FIG. 1.

FIGS. 6A to 6I show end views of example shape and form variations of the device of FIG. 1.

FIGS. 7A to 7I show back views of example shape and form variations of the device of FIG. 1.

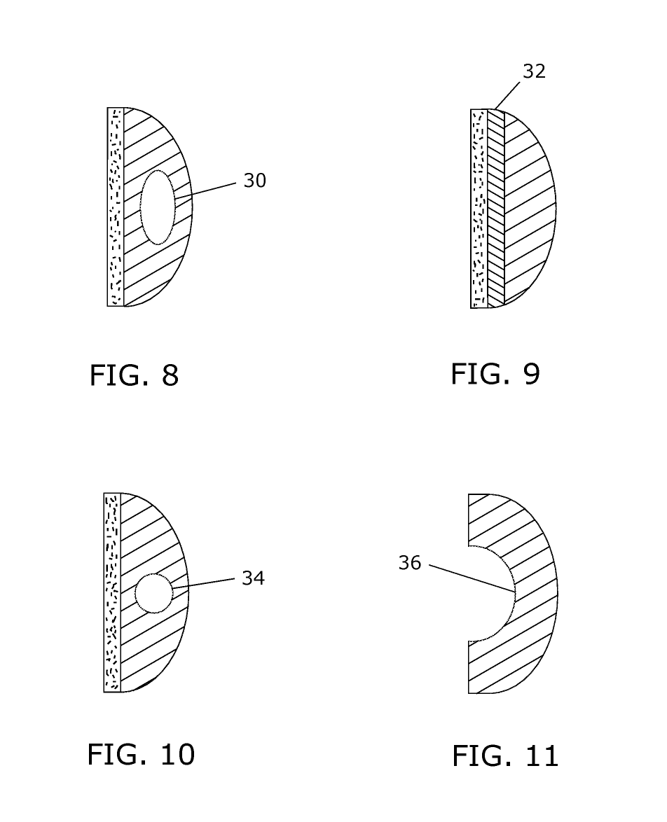

FIG. 8 shows a cross-sectional view of the device of FIG. 1 with a hollow or filled internal chamber.

FIG. 9 shows a cross-sectional view of the device of FIG. 1 composed of an example plurality of layers of differing materials.

FIG. 10 shows a cross-sectional view of a device of FIG. 1 with an internal motion creating device.

FIG. 11 shows a cross-sectional view of an additional embodiment of the device of FIG. 1 with a concave affixing surface.

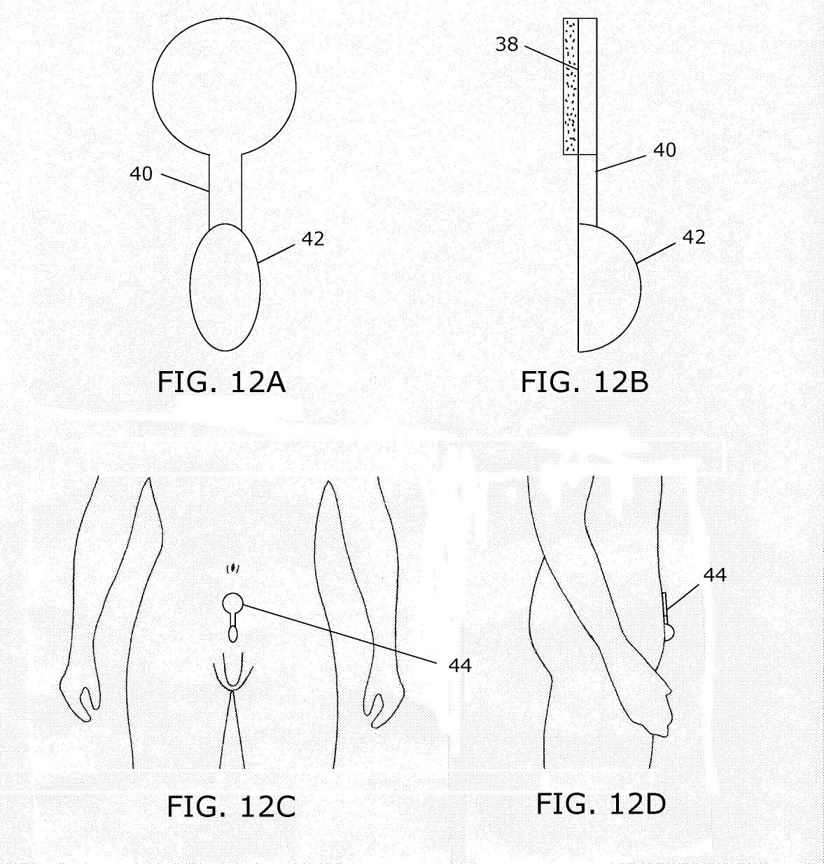

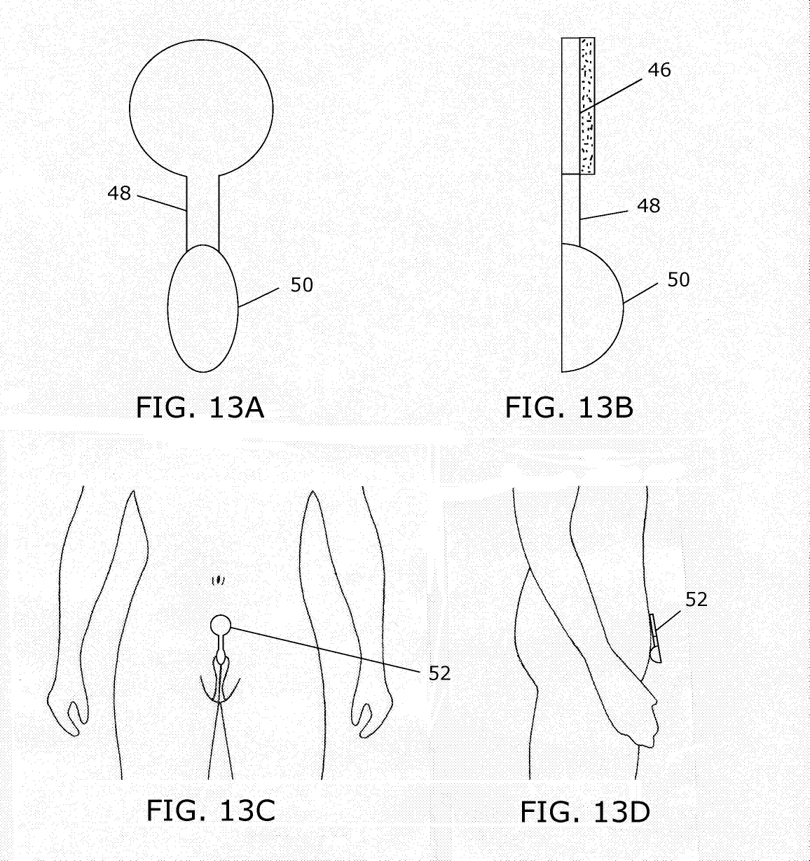

FIGS. 12A and 12B show front and side perspective views of an additional embodiment of the device of FIG. 1 possessing an extension of its affixing surface.

FIGS. 12C and 12D show front and side views of a user of with the device of FIG. 12 affixed to their body.

FIGS. 13A and 13B show front and side perspective views of an additional embodiment of the device of FIG. 12 possessing an alternate affixing surface.

FIGS. 13C and 13D show front and side views of a user of with the device of FIG. 13 affixed to their body.

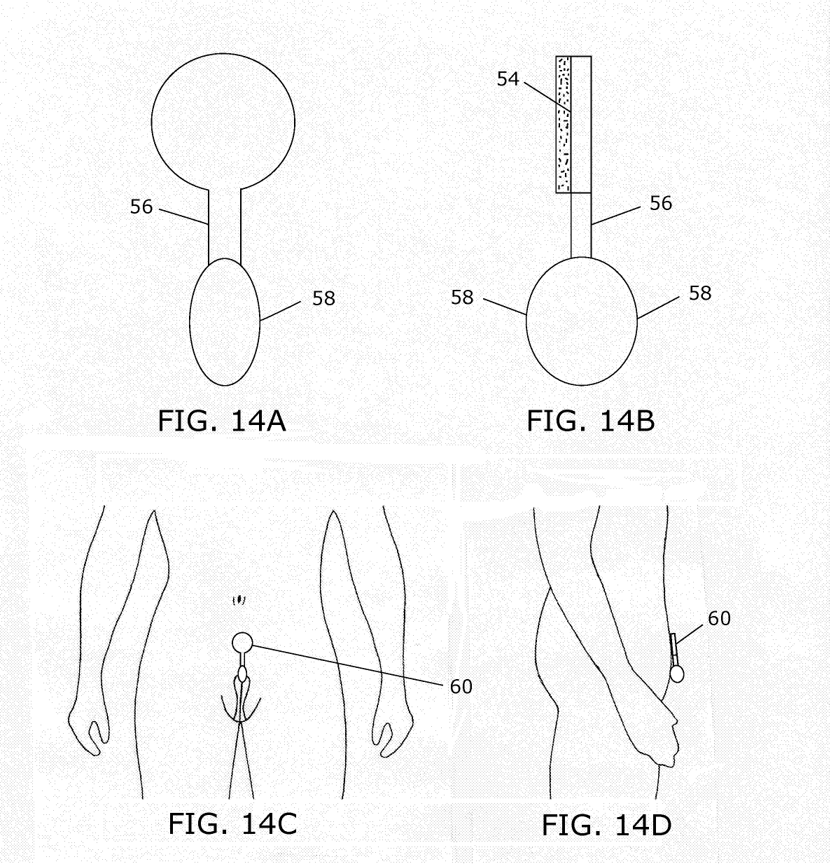

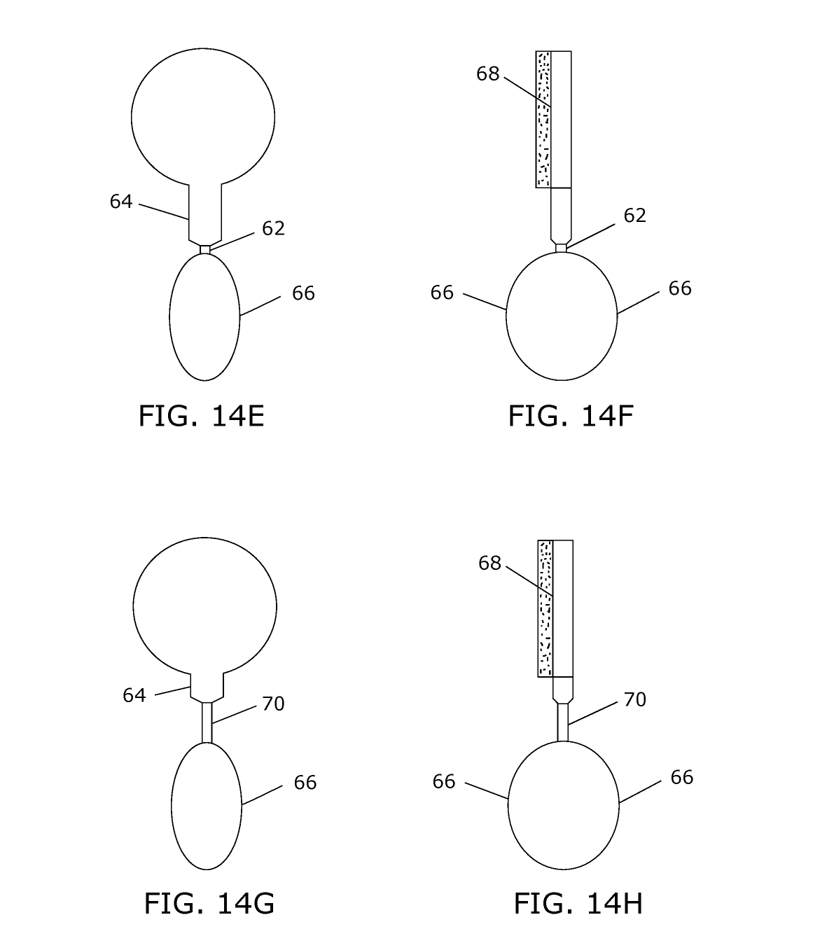

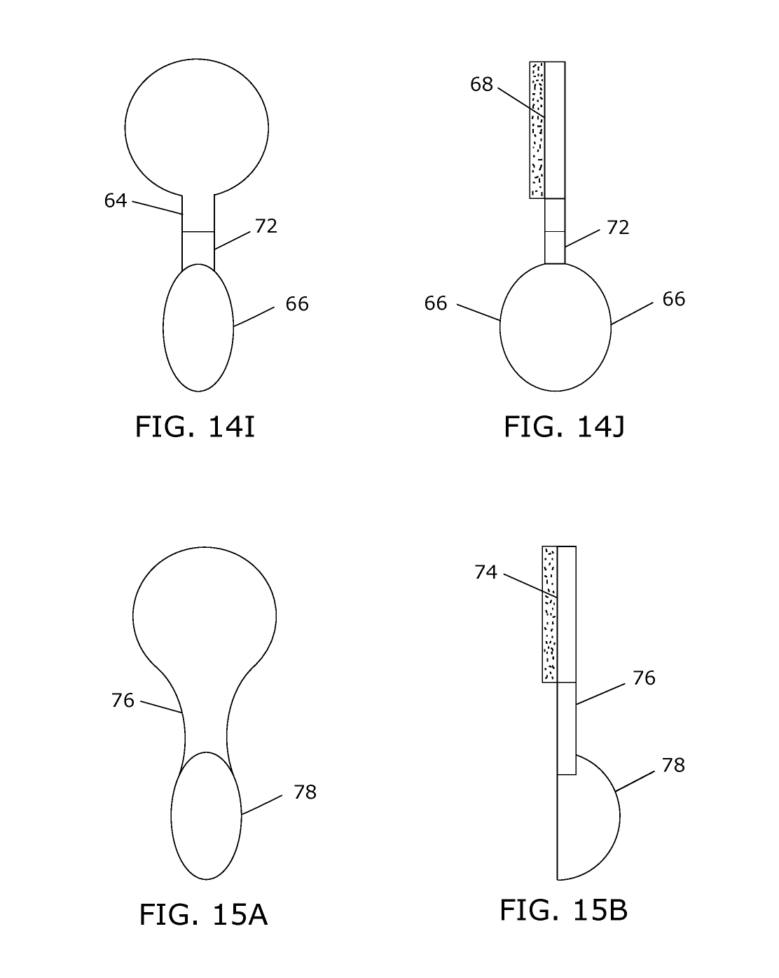

FIGS. 14A and 14B show front and side perspective views of an additional embodiment of the device of FIG. 12 possessing a multidimensional 2-sided clitoral contact surface.

FIGS. 14C and 14D show front and side views of a user of with the device of FIG. 14 affixed to their body.

FIGS. 14E and 14F show front and side views of the device of FIG. 14 with a 2-sided multidimensional clitoral contact surface attached to the extension with a swivel type connector.

FIGS. 14G and 14H show front and side views of the device of FIG. 14 with an extension having reduced girth attached to the 2-sided multidimensional clitoral contact surface.

FIGS. 14I and 14J show front and side views of the device of FIG. 14 made with a material of greater flexibility in all or part of the extension.

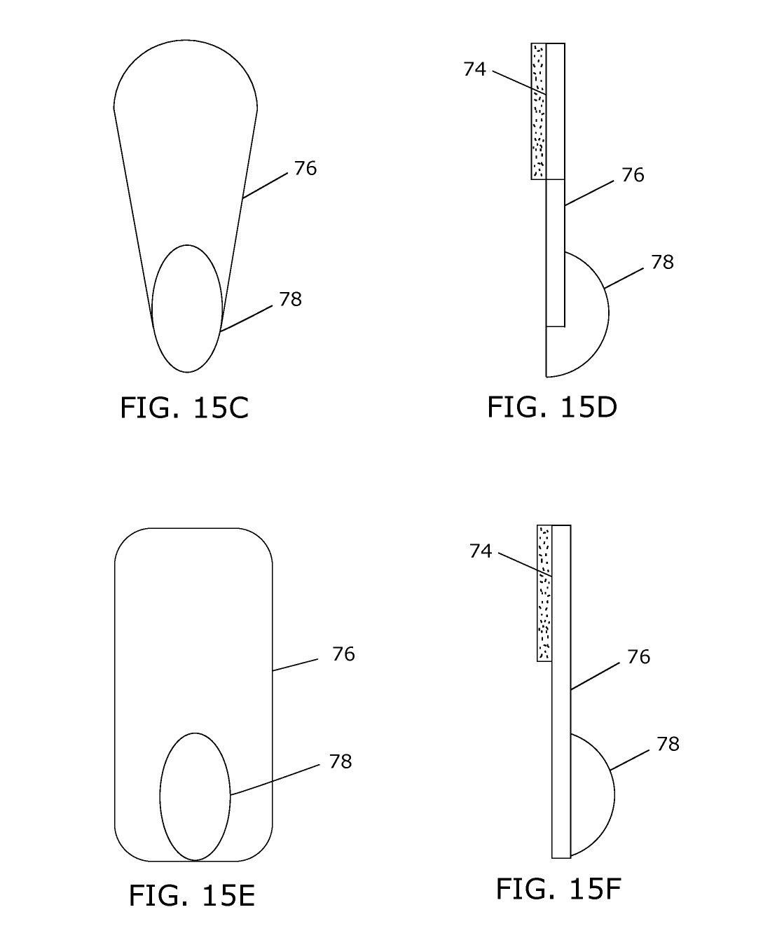

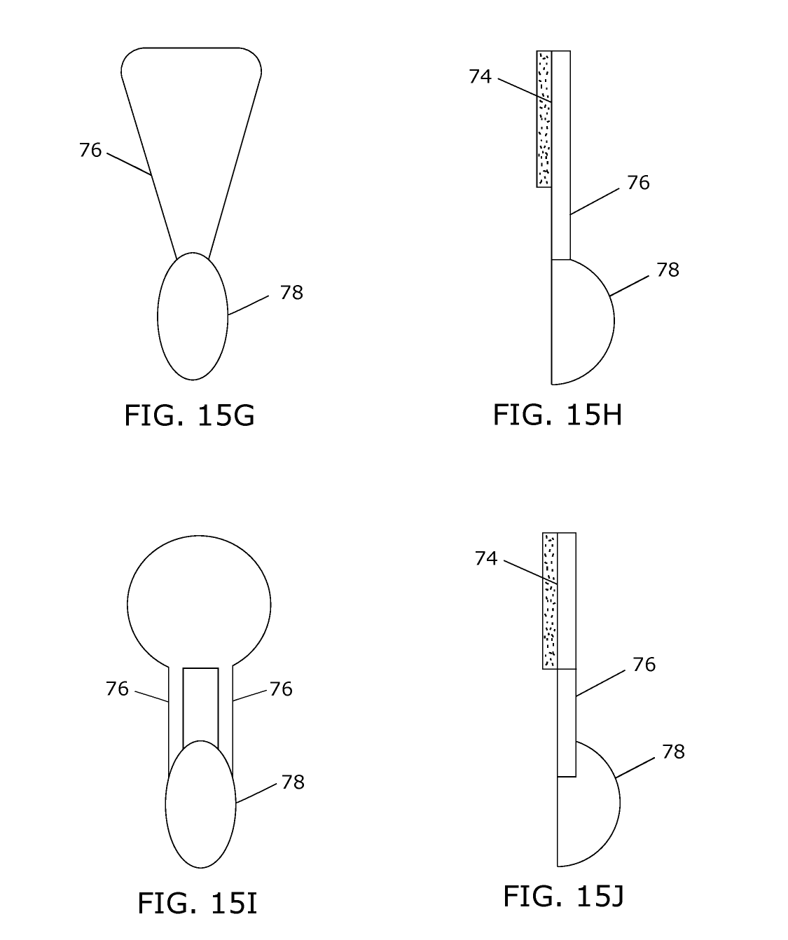

FIG. 15A to 15J show front and side views of example shape and form variations of the extension of the device of FIG. 12.

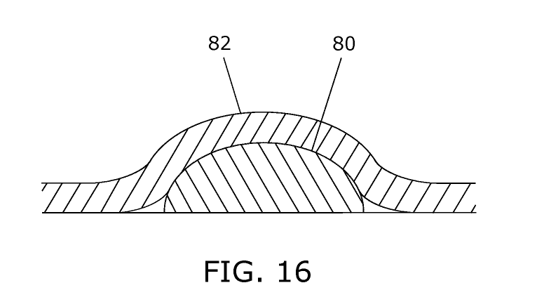

FIG. 16 is a cross-sectional view of the alternate embodiment of the device of FIG. 1 implanted or injected under the epidermis.

Drawings - Reference Numerals

| | |
|---|---|
| 16 affixing surface perimeter | 18 clitoral contact area perimeter |
| 20 affixing surface | 22 affixing adhesive |
| 24 clitoral contact surface | 26 device location |
| 28 device location | 30 internal chamber |
| 32 differing materials | 34 motion creating device |
| 36 concave affixing surface | 38 extended affixing surface |
| 40 affixing surface extension | 42 clitoral contact surface |
| 44 device location | 46 alternate extended affixing surface |
| 48 affixing surface extension | 50 clitoral contact surface |
| 52 device location | 54 extended affixing surface |
| 56 affixing surface extension | 58 multidimensional 2-sided clitoral |
| | contact surface |
| 60 device location | 62 swivel connector |
| 64 affixing surface extension | 66 multidimensional 2-sided clitoral |
| | contact surface |
| 68 extended affixing surface | 70 area of reduced girth |
| 72 material of greater flexibility | 74 extended affixing surface |
| 76 affixing surface extension | 78 clitoral contact surface |
| 80 device location | 82 epidermis |

### DETAILED DESCRIPTION

### FIGS. 1A and 1B

FIG. 1A to 1C show front, side and end perspective views of the basic device in accordance to a first embodiment of the present invention. In this basic example, the size of the device is 1″ high, 0.5″ wide and 0.375″ thick. The device can be made in a multitude of various dimensions in order to achieve differing levels of stimulation.

### DETAILED DESCRIPTION

### FIG. 2

FIG. 2 is a front view of a user positioning and affixing the device 26 of FIG. 1 to their body. The device is to be positioned and affixed to the area of the body that directly opposes the female's clitoris when aligned for intravaginal sexual intercourse

### DETAILED DESCRIPTION

### FIGS. 3A and 3B

FIGS. 3A and 3B show front and side view of a user with the device 26 of FIG. 1 now affixed to their body 28 in preparation for missionary position or woman on top sexual intercourse.

### DETAILED DESCRIPTION

### FIGS. 4A to 7I

FIGS. 4A to 7I show views of example shape and form variations of the device of FIG. 1. The device can be made in a multitude of differing shapes, forms and sizes serving both functional and aesthetic purposes. The device's clitoral contact surface 24 may be planar, radial or irregular. The device's clitoral contact surface 24 may be smooth or of a multitude of various surface finishes, textures and may possess ridges, bumps, depressions, hair or hair like features and secondary surface protrusions.

The device's affixing surface 20 is typically planar, but may have concave or convex characteristics. The affixing surface's perimeter 16 may be larger than the clitoral contact surface's perimeter 18 in order to increase the dimensional area of the affixing surface and achieve a more robust affixation.

### DETAILED DESCRIPTION

### FIG. 8

FIG. 8 shows a cross-sectional view of the device of FIG. 1 with a hollow or filled internal chamber 30. The chamber can be hollow, solid, semi-solid or liquid filled center, or a combination thereof, for variations in cushion and pliability that will provide differing stimulation properties. If the device is made of edible material, the device chamber can be hollow, or made with a solid, semi-solid or liquid filled edible center.

### DETAILED DESCRIPTION

### FIG. 9

FIG. 9 shows a cross-sectional view of the device of FIG. 1 composed of example plurality of layers of differing materials 32. The plurality of differing materials and/or layers of differing materials can provide for differing clitoral stimulation, manufacturing methods and/or affixation techniques.

### DETAILED DESCRIPTION

### FIG. 10

FIG. 10 shows a cross-sectional view of a device of FIG. 1 with an internal motion creating device 34 that produces vibrations and/or gyrations.

### DETAILED DESCRIPTION

### FIG. 11

FIG. 11 shows a cross-sectional view of an additional embodiment of the device of FIG. 1 with a concave affixing surface 36. The device can have one or more concave affixing surfaces that allow it to be affixed though suction or suction plus adhesive.

### DETAILED DESCRIPTION

### FIGS. 12A to 12D

FIGS. 12A and 12B show front and side perspective views of an additional embodiment of the device of FIG. 1 possessing an extension 40 of its affixing surface. The device extension is used to laterally distance the affixing surface 38 from the clitoral contact surface 42, allowing the attachment of the device's affixing surface 38 away from the immediate genital area while still maintaining proper alignment of the clitoral contact surface 42 with the female's clitoral area during the sexual act. In this basic example, the length of the extension 40 is 1.5″ long, 0.375″ wide and 0.125″ thick. These dimensions can vary to allow the user to select styles that suit their individual preferences. The extension 40 and its extended affixing surface 38 can be made of the same material as the clitoral contact surface 42, or of other materials with different physical properties, as well as a plurality of different materials.

FIGS. 12C and 12D show front and side view of a user with the device with an extension 44 affixed to their body in preparation for missionary position or woman on top sexual intercourse.

### DETAILED DESCRIPTION

### FIGS. 13A to 13D

FIGS. 13A and 13B show front and side perspective views of an additional embodiment of the device of FIG. 12 possessing an alternate affixing surface 46. The device can possess an extension 48 and an affixing surface 46 on the same side as the clitoral contact surface 50, allowing a female to attach the device to her own body above the vaginal area.

FIGS. 13C and 13D show front and side view of a user with the device possessing an alternate affixing surface 52 affixed to their body in preparation for sexual activity.

### DETAILED DESCRIPTION

### FIGS. 145A and 14B

FIGS. 14A and 14B show front and side perspective views of an additional embodiment of the device of FIG. 12 possessing a multidimensional 2-sided clitoral contact surface 58. The multidimensional 2-sided clitoral contact surface 58 will provide simultaneous mutual clitoral stimulation between same-sex female couples. This embodiment can also be utilized by heterosexual couples and provide additional clitoral stimulation due to the essential doubling of the typical one-sided clitoral contact surface protrusion thickness 24.

FIGS. 14C and 14D show front and side views of a user with the device with a multidimensional 2-sided clitoral contact surface 58 affixed to their body 60 in preparations for sexual activity.

FIGS. 14E and 14F show front and side views of the device with a multidimensional 2-sided clitoral contact surface protrusion 66 attached to the extension 62 with a swivel type connector 62 that allows movement and pivoting of the multidimensional 2-sided clitoral contact surface 66 during the natural movements of the sexual activity.

FIGS. 14G and 14H show front and side views of the device with a multidimensional 2-sided clitoral contact surface protrusion 66 attached to the extension 64 with reduced girth 70 that allows movement and pivoting of the multidimensional 2-sided clitoral contact surface 66 during the natural movements of the sexual activity.

FIGS. 14I and 14J front and side views of the device with a multidimensional 2-sided clitoral contact surface protrusion 66 attached to the extension with differing material of greater flexibility 72 being used in all or part of the extension 64 that allows movement and pivoting of the multidimensional 2-sided clitoral contact surface 66 during the natural movements of the sexual activity.

### DETAILED DESCRIPTION

### FIGS. 15A to 15J

FIG. 15A to 15J show front and side views of example shape and form variations of the extension design of the device of FIG. 12. The extension 76 of the device can be made in a multitude of differing shapes and forms serving both functional and aesthetic purposes.

### DETAILED DESCRIPTION

### FIG. 16

FIG. 16 is a cross-sectional view of the alternate embodiment of the device of FIG. 1 implanted or injected under the epidermis. The device 80 can be permanently affixed through attachment below the epidermis 82 through surgical implantation or injection.

### OPERATION

### FIGS. 1 to 10—First Embodiment

In operation one uses the sexual stimulator by affixing the device to the body of a female's sexual partner 26 through the use of self-adhesive 22 on its affixing surface 20 or by other means. It is to be positioned on the area of the body that directly opposes the female's clitoris when aligned for intravaginal sexual intercourse; essentially creating an extension of the sexual partner's pubis region. The proper device location can be determined by fully inserting the penis into the vagina and noting the location of the clitoris relative to the partner's body. It may be necessary to remove or shave any body hair present from the relatively small affixing location to assure proper adhesion, as well as prevent any pulling of body hair during removal. The removal of the body hair also provides the added benefit of marking the proper location of the device for future reference. It would be desirable to first clean the body in the location determined for the device's affixation 28 to assure proper adhesion. Once the device is affixed, the couple can participate in intravaginal sexual intercourse as usual but with the added benefit of increased clitoral stimulation resulting from device to clitoral area contact through their natural body movements; increasing physical pleasure as well as the likelihood of achieving orgasm. After the sexual act is complete, the device can be removed from the partner's body 28 and discarded.

This embodiment can also be utilized by same-sex or heterosexual couples by affixing the device to any area of the body that will make contact with the female's clitoral area during a sexual act. It can also be used as a masturbatory tool by affixing it to a finger or other body part, or other thing or object that can make direct contact with her clitoral area.

### OPERATION

### FIG. 11—Additional Embodiment

Operation of the device is the same as in first embodiment, except the use of suction provided by a concave affixing surface 36 is used as the means for affixation. The affixation suction is created by firmly pressing the device's concave affixing surface 36 against the body in the desired location.

### OPERATION

### FIGS. 12A and 12B—Additional Embodiment

Operation of the device is the same as in first embodiment in FIG. 1 except an extension 40 has been added to distance the affixation surface 38 from the clitoral contact surface 42. The extension 40 allows the device's affixing surface 38 to be attached higher on the body 44 and away from the immediate genital area while still maintaining proper alignment of the clitoral contact surface 42 with the female's clitoral area during the sexual act. The extended affixation surface 38 may be advantageous for the user to avoid body hair that may otherwise require removal in order for proper affixation, as well as for other personal reasons.

### OPERATION

### FIGS. 13A and 13B—Additional Embodiment

Operation of the device is the same as in additional embodiment in FIG. 12 except the affixation surface 46 is now on the same side of the device's clitoral contact surface 50. This will allow a female to attach the device's affixation surface 46 to her own body 52 above the vaginal area, instead of attachment to the sexual partner. This will create clitoral area stimulation similar to that achieved when the device is affixed to her sexual partner.

This embodiment can also be used as a masturbatory tool once affixed by rubbing the opposite side of the clitoral contact surface 50 with a finger or other body part, or other thing or object that can make direct contact with her clitoral area.

### OPERATION

### FIGS. 14A to 14J—Additional Embodiment

Operation of the device is the same as in the additional embodiment in FIG. 12 except that the 1 sided clitoral contact surface 50 has been replaced with a multidimensional 2-sided clitoral contact surface 58. When this device is attached to a user's body 60, the multidimensional 2-sided clitoral contact surface 58 will provide a means for same sex female couples to simultaneously stimulate both of their clitoral areas during the sexual act.

This embodiment can also be utilized in the same fashion as the devices of FIGS. 12 and 13 and affixed to either the male or female in heterosexual activity. When utilized in this fashion, the multidimensional 2-sided clitoral contact surface 58 will provide additional pressure and resulting clitoral stimulation by essentially doubling the thickness of the typical clitoral contact surface protrusion 24.

When this embodiment possesses a multidimensional 2-sided clitoral contact surface 66 that is attached to the extension 62 with a means to allow movement, such as a swivel type connector 62, a more flexible area in the extension 64 resulting from reduced girth 70, or a material of greater flexibility 72 being used in all or part of the extension, additional varied clitoral stimulation will occur as the multidimensional 2-sided clitoral contact surface 66 moves and pivots during the natural movements of the sexual act.

### OPERATION

### FIGS. 15A to 15J—Additional Embodiment

Operation of the device is the same as in the additional embodiment in FIG. 12.

### OPERATION

### FIG. 16—Alternate Embodiment

Operation of the device is the same as in first embodiment in FIG. 1 except the device 80 has been permanently affixed through surgical implantation or injection under the epidermis 82.

### CONCLUSIONS, RAMIFICATIONS, AND SCOPE

Accordingly, the reader will see that the device will allow for increased physical pleasure and likelihood of achieving orgasm through direct clitoral area stimulation during intravaginal sexual intercourse. Furthermore, the device has additional advantages in that:
it is securely affixed to a sexual partner's body through the use of temporary self-adhesive or other means.
it is autonomous, independent and free of uncomfortable and unsightly straps, harnesses and/or penis rings.
its relatively small size is unobtrusive and inconspicuous.
it is fully positionable in its affixing location; allowing for a true custom fit for each individual user's vaginal opening to clitoris distance.
it can be easily and quickly affixed or removed with the use of only one hand.
once affixed, the device requires no further adjustments and will maintain its exact position;
allowing continuous proper alignment with the clitoral area during the sexual act.
its relatively small size allows it to be conveniently and discreetly transported in a pocket or purse.
its relatively small size, autonomous nature and relatively sensation-free affixation may allow both sexual partners to forget that it is being utilized.
while it is ideally suited for missionary position and woman on top sexual intercourse, the device can be utilized in any sexual position that allows direct physical contact with the female's clitoral area.
when it is utilized in missionary position or woman on top sexual intercourse, the device will act as an extension of the sexual partner's pubis region.
in addition to providing stimulating pressure and physical manipulation of the clitoris, differing dimensional sizes and shapes of the device will also provide direct stimulation of the labium and outer urethra during the natural motions associated with the act of intravaginal sexual intercourse.
it assists in the manual retraction of the clitoral hood through natural sexual motions; exposing the clitoris and allowing even greater levels of stimulation through direct device to clitoris contact.
its different functional design schemes will facilitate in the creation of differing levels of clitoral hood retraction resulting in differing levels of clitoral stimulation intensity; allowing individual users to choose the specific form that feels best for them.
it can be used by both heterosexual and as same sex couples.
when it is utilized in missionary position or woman on top sexual intercourse, the device will aid in the ability to achieve highly desirable mutual face-to-face orgasms.
it can be used in sexual acts not involving vaginal penetration, and may allow men suffering from erectile dysfunction to provide their sexual partners with a face-to-face orgasm through clitoral stimulation while enjoying the intimacy of total body contact provided by the missionary position.
it can be used as a masturbatory tool by affixing it to the finger or other body part of the female user, or other thing or object that can make direct contact with her clitoral area.
it can be made in a multitude of different sizes and thicknesses that will provide unique stimulating properties; allowing individual users to choose the specific form that feels best for them.
it can be made in a multitude of different outer perimeter contours that will provide unique stimulating properties; allowing individual users to choose the specific form that feels best for them.
its raised clitoral contact surface profile can be made planar, convex, concave, irregular, or a combination thereof.
its raised clitoral contact surface can include one or more raised areas, ridges, bumps and secondary protrusions that will provide unique stimulating properties; allowing individual users to choose the specific form that feels best for them.
its raised clitoral contact surface can include one or more secondary concave areas and depressions extending into the surface creating suction cup like features that will provide unique suction stimulation properties; allowing individual users to choose the specific form that feels best for them.
its raised clitoral contact surface can be made with a multitude of different surface finishes and textures that will provide differing stimulation properties; allowing individual users to choose the specific form that feels best for them.
it can be made in a multitude of different aesthetic shapes, forms and designs; allowing individual users to choose a specific aesthetic appearance that appeals to their unique visual preferences, possibly making a fashion statement.
it can be made of inconspicuous clear material or in various aesthetically pleasing opaque or translucent colors, luminescent, or a combination thereof; allowing individual users to choose colors associated with their unique color preferences, possibly making a fashion statement.
if made of luminescent material, the luminescence will aid the user in locating and placement of the device when adequate lighting is not present.
it can be made from a wide selection of materials that will provide differing stimulation properties; allowing individual users to choose specific materials that feel best for them.
it can be made in different levels of firmness that will provide differing stimulating properties;
allowing individual users to choose the specific pliancy that feels best for them.
it can be made from a wide selection of materials that will provide differing heat transfer properties; allowing individual users to choose specific materials that feel best for them.
it can be made from a wide selection of materials; allowing individual users to choose specific materials that will not trigger inherent allergic reactions.
it can be made with a hollow, solid, semi-solid or liquid filled center, or a combination thereof, for variations in cushion and pliability that will provide unique stimulating properties; allowing individual users to choose specific materials that feel best for them.
it can be comprised of a plurality of differing materials and/or layers of differing materials; allowing for different clitoral stimulation, manufacturing methods and affixation techniques.
as a result of all aspects of its raised clitoral contact surface making contact with the clitoral area of the individual; all differing shapes, forms, designs and material selections of the device are fully functional features in stimulation creation, in additional to any ornamental or aesthetic qualities they may possess. The only aspect of design that is purely aesthetic in nature is color.
it can be easily mass produced through the use of molds, die cutting, impression, injection, extrusion or other manufacturing techniques; allowing a relatively low cost of production resulting in a relatively low cost for retail consumers.
its relatively low retail cost due to efficient mass production will make it economically practical to dispose of the device after use; allowing the user to utilize a new and fresh device for each sexual experience.
its disposable nature will eliminate the need for cleaning, sterilization and other sanitary precautions that would otherwise be required for reuse.
it can be made of edible material.
if it is made of edible material, the device can also possess a hollow, solid, semi-solid or liquid filled center edible center.
if it is made of edible candy-type material, the device may add to the taste enjoyment of performing oral sex through the melting and/or dissolving of the candy material onto each sexual partner's body.
it can contain a motion creating device; producing vibrations and/or gyrations.
its affixing surface's perimeter can be larger than the clitoral contact surface's perimeter in order to increase the dimensional area of the affixing surface and achieve a more robust affixation.
it can have an extension to laterally distance the affixing surface from the clitoral contact surface, allowing the attachment of the device's affixing surface on the body away from the immediate genital area while still maintaining proper alignment of the clitoral contact surface with the female's clitoral area during the sexual act. This can be advantageous for the user to avoid body hair that may otherwise require removal in order for proper affixation, as well as for other personal reasons.
when it possesses an extension and the affixing surface is located on the same side as the clitoral contact surface, a female can attach the device to her own body above the vaginal area and receive clitoral stimulation during a sexual act or masturbation session.
when it possesses an extension and a multidimensional 2-sided clitoral contact surface, the device will provide simultaneous clitoral stimulation between same-sex female couples during a sexual act.
the extended multidimensional 2-sided clitoral contact surface can also be utilized by heterosexual couples and provide additional pressure and resulting clitoral stimulation by the essential doubling the thickness of the typical clitoral contact surface protrusion.
if the clitoral contact surface is attached to the extension with a means to allow movement, additional varied clitoral stimulation will occur as the clitoral contact surface moves and pivots during the natural movements of the sexual act.
it can be affixed in a permanent nature below the epidermis through surgical implantation, injection or by permanent attachment to the outer surface of the epidermis.

Although the description above contains many specifications, these should not be construed as limiting the scope of the embodiments but merely providing illustrations of some of several embodiments. For example, the device can be utilized in numerous different sexual positions; the device can be affixed through the use of numerous forms of adhesive, such as tape, dry, liquid or self-adhesive; the device can be affixed though non-adhesive such as suction or other means; the device can be made to have other means of affixation; the device can be made in a multitude of different outer perimeter contours, such as square, rectangular, trapezoidal, heart, diamond, arrow, atypical and asymmetrical contours such as alphabetic letters, irregular abstract forms, etc.; the device can be made in a multitude of different figural styles and shapes, such as that of an animal, human and human body parts, plant, object, bullet, finger, tongue, lips, penis, swirl, geographical map region, etc.; the device can be made in a multitude of different length, width and thickness dimensions; the device can be made in a multitude of different clitoral contact surface edge profiles, such as sharp, rounded, beveled, grooved, beaded, etc.; the device can be made in a multitude of other different clitoral contact surface profiles and contours; the device can be made in a multitude of other clitoral contact surface finishes, textures, ridges, bumps, concave features and secondary protrusions, including hair or hair-like features; the device's affixation surface extension can be made of a multitude of different materials; the device's affixation surface extension can be made in a multitude of different lengths, width, thicknesses, shapes and forms; the device can have multiple affixation surface extensions; the device's affixation surface extensions can have areas void of material; the multidimensional 2-sided clitoral contact surface can be made in a multitude of different sizes; the multidimensional 2-sided clitoral contact surface can take on a multitude of multidimensional shapes and forms including spherical, cylindrical, cubical, egg, figural, abstract, etc.; the multidimensional 2-sided clitoral contact surface can be attached to the extension with a means that allows freedom of movement.

Thus the scope of the embodiments should be determined by the appended claims and their legal equivalents, rather than by the examples given.

I claim:

1) A device which provides clitoral area stimulation comprised of an independent positionable protrusion affixed to the body of a sexual partner in the area opposing the female's clitoris, allowing for protrusion to clitoral area contact during the sexual act.

2) The device as recited in claim 1 wherein said protrusion has at least one planar affixing surface.

3) The device as recited in claim 1 wherein said protrusion is affixed to the epidermis.

4) The device as recited in claim 1 wherein said protrusion is affixed by adhesive.

5) The device as recited in claim 1 wherein said protrusion's clitoral contact surface profile is radial.

6) The device as recited in claim 1 wherein said protrusion has one or more secondary protrusions extending out from its clitoral contact surface.

7) The device as recited in claim 1 wherein said protrusion has one or more concave areas extending into its clitoral contact surface.

8) The device as recited in claim 1 wherein said protrusion is composed of a plurality of differing materials.

9) The device as recited in claim 1 wherein said protrusion has at least one concave affixing surface.

10) The device as recited in claim 1 wherein said protrusion has one or more hollow internal chambers.

11) The device as recited in claim 1 wherein said protrusion has one or more filled internal chambers.

12) The device as recited in claim 1 wherein said protrusion is edible.

13) The device as recited in claim 1 wherein said protrusion is disposable.

14) The device as recited in claim 1 wherein said protrusion contains a motion creating device.

15) The device as recited in claim 1 wherein said protrusion's has one or more extensions to laterally distance the affixation surface from the clitoral contact surface.

16) The device as recited in claim 15 wherein said protrusion has a multidimensional 2-sided clitoral contact surface.

17) The device as recited in claim 15 wherein said clitoral contact surface is attached to the extension with a swivel connection apparatus.

18) The device as recited in claim 15 wherein said extension has at least one area of reduced girth.

19) The device as recited in claim 15 wherein said extension has at least one area consisting of a material of greater flexibility.

20) The device as recited in claim 1 wherein said protrusion is affixed through implantation under the epidermis.
